(19) United States
(12) Patent Application Publication
(10) Pub. No.: US 2010/0256880 A1
(43) Pub. Date: Oct. 7, 2010

(54) VEHICLE CONTROL APPARATUS

(75) Inventor: Tsuyoshi Sato, Aichi (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi, Aichi (JP)

(21) Appl. No.: 12/599,215

(22) PCT Filed: Oct. 7, 2008
(86) PCT No.: PCT/JP2008/068220

§ 371 Date: Nov. 6, 2009

(30) Foreign Application Priority Data
Nov. 28, 2007 (JP) 2007-307053

(51) Int. Cl. G06F 19/00; F16H 61/28

(52) U.S. Cl. 701/55

(57) ABSTRACT

In a control apparatus (3, 40) of a vehicle in which a by-wire range switching apparatus (10) that performs range switching of an automatic transmission 2 using an actuator 60 is mounted, even if a range switching failure occurs in the course of performing range switching in a specific pattern (for example, R→D, or D→R) so as to reverse the present drive power direction, vehicle movement can be suppressed or prevented as much as possible.

The control apparatus (3, 40) includes a coping means (Steps S1 and S5) that, when the request to switch to a forward range or a reverse range has been identified as a request in that specific pattern, reduces the generated output of a drive source 1 to a lower limit side, and an execution means (Steps S2, S4, and S6) that controls the range switching apparatus 10 so as to establish the requested range.

### TECHNICAL FIELD

The present invention relates to a control apparatus that controls operation of a vehicle such as an automobile. In the vehicle controlled by this control apparatus, a configuration is presumed in which a by-wire range switching apparatus that performs range switching of an automatic transmission using an actuator has been mounted.

### BACKGROUND ART

In a vehicle in which an engine (internal combustion engine) is mounted, as a transmission that appropriately transmits the torque and revolution speed generated by the engine to drive wheels according to the vehicle running state, an automatic transmission is known that automatically optimally sets a gear ratio between the engine and the drive wheels.

As an automatic transmission mounted in a vehicle, for example, a planetary gear transmission that makes numerous gears using a plurality of clutches and brakes and a planetary gear mechanism, and a belt-driven stepless transmission (CVT: Continuously Variable Transmission) that steplessly adjusts the gear ratio, and so forth are known.

In a vehicle in which a planetary gear automatic transmission is mounted, ordinarily, a gearshift map that has gearshift lines (gear switching lines) for obtaining an optimal gear according to the vehicle speed and a throttle opening degree (or accelerator opening degree) is stored in a memory of a vehicle control apparatus, a target gear is calculated with reference to the gearshift map based on the vehicle speed and the throttle opening degree, and based on that target gear, a gear is automatically set by engaging or releasing a clutch, a brake, a one-way clutch, and the like, which are frictionally engaging elements, in a predetermined state.

As a control apparatus that controls such an automatic transmission, there is a so called by-wire range switching apparatus (for example, see PTL 1) that electrically detects the position of the shift range of the automatic transmission using a sensor, and by driving an actuator of an electric motor or the like for shift switching based on this detection signal to switch a manual valve of the automatic transmission, switches a shift position such as P (parking), R (reverse), N (neutral), and D (drive).

In a by-wire range switching apparatus, range switching of the automatic transmission is performed by an ordinary mechanically operated range switching apparatus, i.e., by a driver operating a direct detent mechanism using a shift lever operation via wire. In this range switching apparatus, it is not necessary for the shift lever and the detent mechanism to be mechanically linked by wire, so the layout when mounting these parts in the vehicle is not restricted, and thus there are the advantages that it is possible to increase design freedom, and also that installation in the vehicle can easily be performed.

In a vehicle in which such a by-wire range switching apparatus is mounted, a failsafe is necessary when a problem has occurred in range switching. Control of this failsafe is described in PTL 2.

With the technology described in PTL 2, in an automatic transmission that employs by-wire control, a gearshift range position (target range position) that has been selected by a driver with a shift switching operation is compared to the actual range position of the automatic transmission, and when these are not the same, a judgment is made that a problem has occurred in the automatic transmission. When judged that a problem has occurred in the automatic transmission, by blocking a power transmission path from a crankshaft of the engine to the drive wheels via the automatic transmission, vehicle movement in a range position different from the range position selected by the driver is prevented.

Also, with the technology described in PTL 2, for example, the power transmission path is blocked by releasing a forward engaging element (clutch) or rearward engaging elements (clutch and brake) of the automatic transmission.

### CITATION LIST

### [Patent Literature]

### [PTL 1]

### JP 2000-170905A

### [PTL 2]

### JP 2004-125061A

### SUMMARY OF INVENTION

### Technical Problem

Incidentally, in a vehicle in which a by-wire range switching apparatus has been mounted, as described above, although a failsafe control that blocks the power transmission path when a range switching failure (for example, the actual range is not the same as the target range) has occurred is performed, the failsafe control is performed after occurrence of the range switching failure has been detected, and so there is a concern that the effects of performing the failsafe control will be inadequate. In this regard there is room for improvement in the conventional technology.

It is an object of the present invention, in a control apparatus of a vehicle in which a by-wire range switching apparatus that performs range switching of an automatic transmission using an actuator has been mounted, to make it possible to suppress as much as possible or prevent movement of the vehicle even if a range switching failure occurs in the course of performing range switching in a specific pattern so as to reverse a present drive power direction.

Also, it is an object of the present invention, in a control apparatus of a vehicle in which a by-wire range switching apparatus that performs range switching of an automatic transmission using an actuator has been mounted, to make it possible to suppress as much as possible or prevent movement of the vehicle even if a range switching failure occurs in the course of performing range switching in a specific pattern so as to reverse a present drive power direction, and furthermore to make it possible to maintain good response to an acceleration request of the driver when range switching other than in the specific pattern has been properly completed.

### Solution to Problem

The present invention provides a control apparatus of a vehicle in which a by-wire range switching apparatus that performs range switching of an automatic transmission using an actuator is mounted, the control apparatus including: a coping means that, when a range switching request is identified to be in a specific pattern that reverses the present drive power direction, increases the degree of restriction of drive power transmission compared to a case of a range switching request that is not in that specific pattern.

According to this configuration, even if a range switching failure occurs and thus the requested range cannot be established, drive power transmission to the drive wheels is restricted, so vehicle movement can be suppressed.

In this configuration, it is possible to restrict drive power as described above both in the case of range switching in the specific pattern and in the case of range switching that is not in the specific pattern. Also, it is possible to adopt a configuration in which in the case of range switching that is not in the specific pattern, drive power transmission is not restricted. In either case, it is beneficial to adopt a configuration in which the degree of drive power restriction is greater in the case of range switching in the specific pattern than in the case of range switching that is not in the specific pattern.

The present invention provides a control apparatus of a vehicle in which a by-wire range switching apparatus that performs range switching of an automatic transmission using an actuator is mounted, the control apparatus including: a coping means that, when a range switching request is identified to be in a specific pattern that reverses the present drive power direction, decreases output of a drive source mounted in the vehicle to a lower limit side; and an execution means that controls the range switching apparatus so as to establish the requested range.

According to this configuration, even if a range switching failure occurs and thus the requested range cannot be established, only drive power due to lower limit side output generated by the drive source is transmitted to the drive wheels, so vehicle movement can be suppressed.

Furthermore, by adopting a configuration in which when a range switching request other than in the specific pattern has been received, a measure of decreasing output of the drive source to the lower limit side as described above is not performed, in a case where the range switching has been properly completed, it is possible to immediately transmit corresponding drive power to the drive wheels when an acceleration request by the driver was received near the time of that range switching. Thus, response to an acceleration request when range switching was properly performed is well maintained.

Also, the present invention provides a control apparatus of a vehicle in which a by-wire range switching apparatus that performs range switching of an automatic transmission using an actuator is mounted, and also a hydraulic power transmission adjustment means that adjusts drive power transmission from a drive source to drive wheels is mounted, the control apparatus including: a coping means that, when a range switching request is identified to be in a specific pattern that reverses the present drive power direction, decreases output of the drive source to a lower limit side; an execution means that controls the range switching apparatus so as to establish the requested range; a confirmation means that checks whether the executed range switching has been properly completed, or a failure has occurred due to an operation malfunction during the range switching; and a measuring means that, when occurrence of a failure has been detected by the confirmation means, restricts drive power transmission with the power transmission adjustment means.

According to this configuration, even if a range switching failure occurs and so the requested range cannot be established, and an operating delay occurs that is a concern when executing a failure measure, during that delay, only drive power due to lower limit side output generated by the drive source is transmitted to the drive wheels, so vehicle movement can be suppressed.

Furthermore, when a range switching request other than in the specific pattern has been received, a measure of decreasing output of the drive source to the lower limit side as described above is not performed, so in a case where the range switching has been properly completed, when an acceleration request by the driver was received near the time of that range switching, it is possible to immediately transmit corresponding drive power to the drive wheels. Thus, response to an acceleration request when range switching was properly performed is well maintained.

Preferably, in the above control apparatus, the drive source is an engine, and an idling state of this engine is the lower limit side of the drive source output.

By adopting such a configuration, in the delay period, the drive power transmitted to the drive wheels is of a level that can be ignored, which is advantageous for suppressing or preventing vehicle movement.

Also, the present invention provides a control apparatus of a vehicle in which a by-wire range switching apparatus that performs range switching of an automatic transmission using an actuator is mounted, and also a hydraulic power transmission adjustment means that adjusts drive power transmission from a drive source to drive wheels is mounted, the control apparatus including: a coping means that, when a range switching request is identified to be in a specific pattern that reverses the present drive power direction, restricts drive power transmission by the power transmission adjustment means; and an execution means that controls the range switching apparatus so as to establish the requested range.

According to this configuration, even if a range switching failure occurs and thus the requested range cannot be established, drive power transmission to the drive wheels is restricted, so vehicle movement can be suppressed.

Furthermore, by adopting a configuration in which when a range switching request other than in the specific pattern has been received, a measure of restricting drive power as described above is not performed, in a case where the range switching has been properly completed, it is possible to immediately transmit corresponding drive power to the drive wheels when an acceleration request by the driver was received near the time of that range switching. Thus, response to an acceleration request when range switching was properly performed is well maintained.

Preferably, the control apparatus further includes: a confirmation means that checks whether the executed range switching has been properly completed, or a failure has occurred due to an operation malfunction during the range switching; and a measuring means that, when occurrence of a failure has been detected by the confirmation means, restricts drive power transmission with the power transmission adjustment means.

According to this configuration, even if a range switching failure occurs and so the requested range cannot be established, and an operating delay occurs that is a concern when executing a failure measure, during that delay, drive power transmission to the drive wheels is restricted, so vehicle movement can be suppressed.

Furthermore, when a range switching request other than in the specific pattern has been received, a measure of restricting drive power as described above is not performed, so in a case where the range switching has been properly completed, it is possible to immediately transmit corresponding drive power to the drive wheels when an acceleration request by the driver was received near the time of that range switching. Thus, response to an acceleration request when range switching was properly performed is well maintained.

Also, it is preferable to adopt a configuration in which the coping means, when restricting drive power transmission with the power transmission adjustment means due to receiving a range switching request in the specific pattern, when a low oil temperature is detected based on output of an oil temperature detection means for detecting a working oil temperature of the automatic transmission, increases the degree of restriction compared to when a high oil temperature is detected.

First, in the operation of the hydraulic power transmission adjustment means, when the working oil temperature is high, viscosity of the working oil is low so response is good, but when the working oil temperature is low, viscosity of the working oil is high so response is poor.

Therefore, in consideration of the fact that when the working oil temperature is low, response of the power transmission adjustment means is poor, by setting a larger degree of restriction by the power transmission adjustment means than when the working oil temperature is high, the operating delay (for example, clutch release delay) of drive power restriction can be reduced. However, when the working oil temperature is high, response of the power transmission adjustment means is good, so even if drive power is restricted after a range switching failure is detected, an operating delay is unlikely to occur.

Preferably, the power transmission adjustment means is configured with frictionally engaging elements provided in the automatic transmission. By adopting such a configuration, a new installation for the power transmission adjustment means is not necessary, which is advantageous for suppressing an increase in initial cost or vehicle weight.

Preferably, the range switching apparatus provided in a vehicle controlled by any of the above control apparatuses includes a detent mechanism for changing the state of a manual valve that is one constituent element of a range switching hydraulic control apparatus provided in the automatic transmission, and an actuator for driving the detent mechanism; the detent mechanism including a detent member that is displaced by the actuator and a positioning member that maintains a stopped posture of the detent member; the detent member having a wave-shaped portion constituted from a plurality of valleys that correspond to each range to which the switching is performed and mountains between the valleys, and the positioning member having an engaging portion that engages with a valley of the wave-shaped portion and generates a biasing force that pushes the engaging portion towards the valley bottom. In the case of a range switching apparatus with such a configuration, it is preferable that the control apparatus controls the actuator to establish a requested range when a range switching request has been received.

Such a configuration can be given as an example of the configuration of the range switching apparatus provided in a vehicle controlled by any of the above control apparatuses.

Preferably, the actuator tilts the detent member, and includes an electric motor that generates rotational power, and a deceleration mechanism that decelerates the rotational power generated by this motor and outputs the decelerated rotational power from an output shaft that is linked coaxially and so as to be capable of rotating as a single body with a support shaft of the detent member.

In this way, if the form of operation of the detent member, the form of power generation by the actuator, and so forth are specified, it is possible to make clear the configuration of the range switching apparatus.

Furthermore, it is preferable to adopt a configuration in which the control apparatus of a vehicle provided with the specific range switching apparatus includes a rotor angle detection means that detects the rotation angle of a rotor of the motor, and an output angle detection means that detects the rotation angle of the output shaft of the actuator; the execution means performing processing that, in response to a range switching request, sets a target rotation angle of the motor that is necessary to engage a valley corresponding to the requested range to the engaging portion, and performs feedback control of driving of the motor until the detected output (actual rotation angle) of the rotor angle detection means reaches the target rotation angle. In this way, when using a tilting type of detent member, it is possible to make clear the form of control of range switching.

In the above configuration, it is preferable to adopt a configuration in which in the control apparatus of a vehicle provided with the specific range switching apparatus, the confirmation means, when driving of the motor is stopped, determines whether or not a failure has occurred by checking whether or not the valley corresponding to the requested range has been engaged with the engaging portion, based on output of the output angle detection means.

In this way, it is possible to make clear the form of range switching failure when using a tilting type of detent member.

### ADVANTAGEOUS EFFECTS OF INVENTION

According to the present invention, even if a range switching failure occurs in the course of performing range switching in a specific pattern so as to reverse the present drive power direction, vehicle movement can be suppressed or prevented as much as possible.

Also, according to the present invention, in addition to the above effects, when range switching other than in the specific pattern has been properly completed, response to an acceleration request of the driver can be maintained well.

### BRIEF DESCRIPTION OF DRAWINGS

FIG. 1 is a block diagram that shows the general configuration in one embodiment of a vehicle control apparatus according to the present invention.

FIG. 2 is a perspective view that shows a range switching pattern of a shift lever used in a range switching apparatus in FIG. 1.

FIG. 3 is a skeleton diagram that shows the general configuration in one embodiment of an automatic transmission in FIG. 1.

FIG. 4 is an operation table of the automatic transmission shown in FIG. 3.

FIG. 5 is a perspective view that shows the general configuration of the range switching apparatus in FIG. 1.

FIG. 6 is a side view that shows a cross-section taken along a linked portion of an output shaft of an actuator in FIG. 1 and a support shaft of a detent plate.

FIG. 7 is a flowchart used to describe operation by the control apparatus in FIG. 1.

FIG. 8 is a flowchart used to describe operation in another embodiment of a vehicle control apparatus according to the present invention.

### DESCRIPTION OF EMBODIMENTS

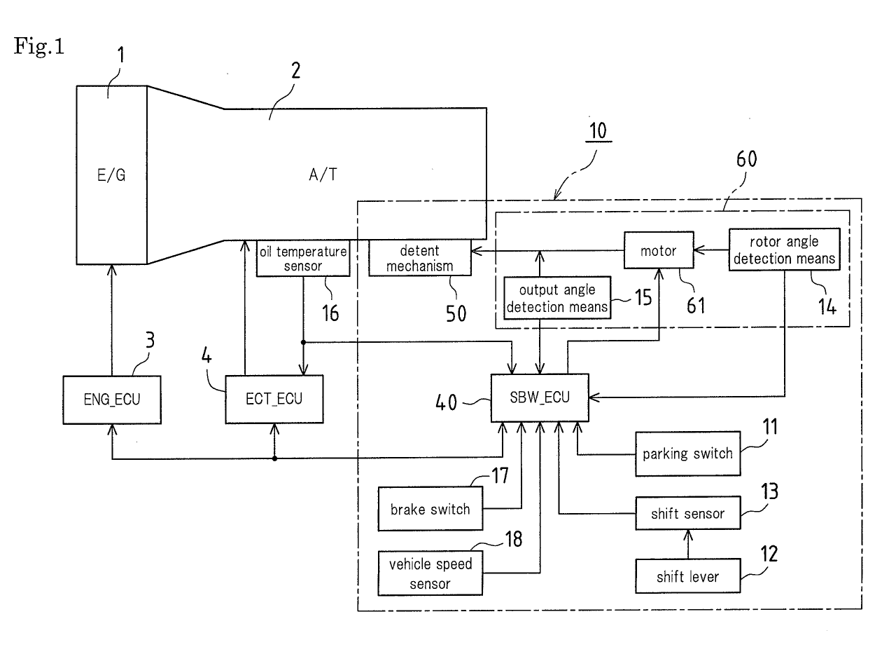

Following is a detailed description of embodiments of the invention based on the drawings. FIGS. 1 to 7 show an embodiment of the invention.

Here, before describing portions in which features of the present invention are applied, the presumed configuration of a vehicle controlled by a control apparatus of the invention will be described with reference to FIGS. 1 to 4.

FIG. 1 shows an engine (internal combustion engine) 1 used as a drive source, an automatic transmission 2, and a range switching apparatus 10.

For example, a gasoline engine, diesel engine, LPG engine or the like is applicable as the engine 1, which is mounted in a vehicle such as an automobile. The engine 1 burns a mixture of fuel and air in a cylinder, and converts that heat energy to rotational motion energy and outputs that energy. Operation of this engine 1 is controlled by an ENG-ECU (Electronic Control Unit) 3.

The automatic transmission 2, for example, responds to manual operation of a parking switch 11, a shift lever 12, and so forth that are installed in the vicinity of a vehicle driver's seat by a driver, to establish, for example, a parking range P, a reverse range R, a neutral range N, a drive range D, or the like. This operation of the automatic transmission 2 is controlled by an ECT (Electronically Controlled automatic Transmission)_ECU 4.

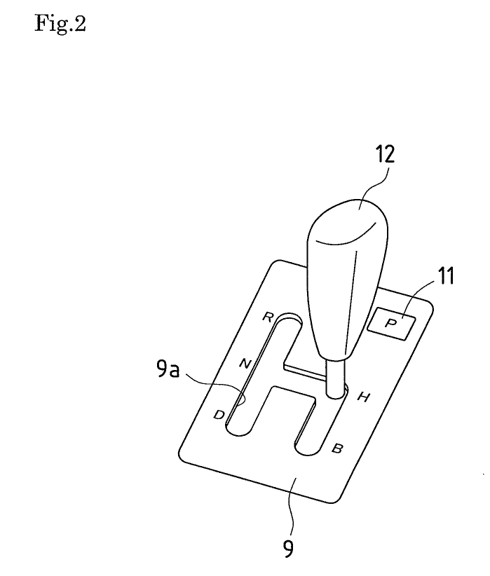

The form of the parking switch 11 and the shift lever 12 will be described with reference to FIG. 2.

The parking switch 11, each time that the parking switch 11 is pressed by a person, alternately outputs a signal corresponding to the parking range P and a signal corresponding to a non-parking range NP, and for example, is installed at a predetermined position of a shift base 9 that is installed near the driver's seat.

The parking switch 11 is a so-called toggle switch or the like that switches between two states each time that the parking switch 11 is pressed by a person.

The shift lever 12 is installed in the vicinity of the parking switch 11 in the shift base 9, and along with receiving a tilting operation by a person, causes output of an appropriate signal (a signal corresponding to the neutral range N, a signal corresponding to the reverse range R, a signal corresponding to the drive range N, or the like) from a shift sensor 13.

The shift lever 12 is a so-called momentary-type shift lever, and with a home position H in a shift gate 9a of the shift base 9 as a starting point, is capable of tilting operation to a neutral position N, a reverse position R, a drive position D, or an engine brake position B. After tilting operation of the shift lever 12 from the home position H to the neutral position N, the reverse position R, the drive position D, or the engine brake position. B, the shift lever 12 automatically returns to the home position H.

The shift sensor 13 outputs a signal corresponding to the neutral range N when the shift lever 12 has been tilted in one lateral direction from the home position H to be tiltingly operated to the neutral position N, outputs a signal corresponding to the reverse range R when the shift lever 12 has been tiltingly operated from the neutral position N towards the reverse position R in the forward direction, outputs a signal corresponding to the drive range D when the shift lever 12 has been tiltingly operated from the neutral position N towards the drive position D in the rearward direction, and outputs a signal for putting into effect an engine brake when the shift lever 12 has been tiltingly operated from the home position H towards the engine brake position B in the rearward direction.

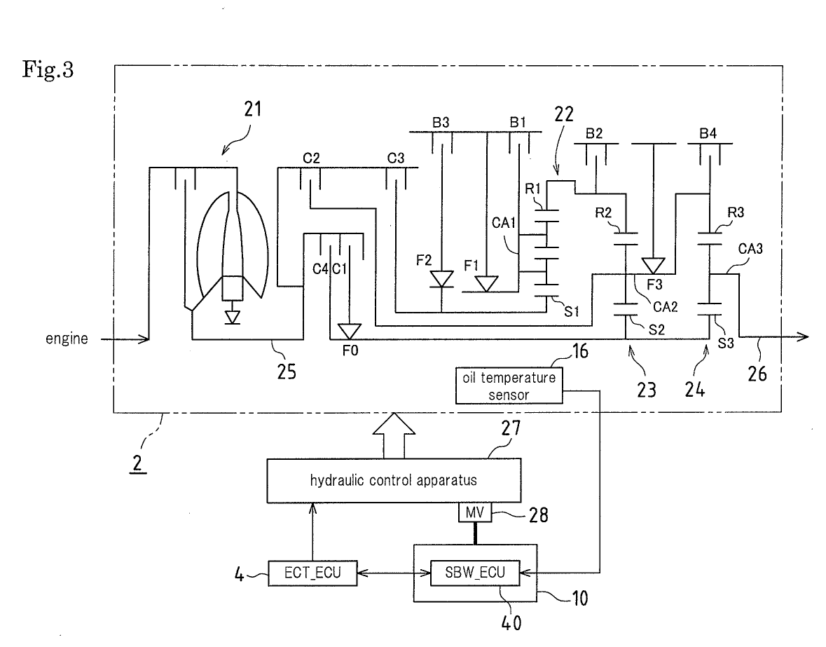

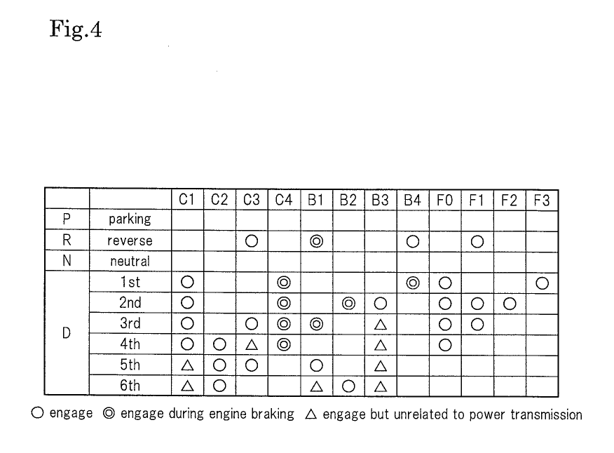

The general configuration of the automatic transmission 2 will be described with reference to FIGS. 3 and 4. The automatic transmission 2 shown in FIG. 3 is a type of automatic transmission mounted in an FR (Front Engine/Rear Drive)-type vehicle. The automatic transmission 2 is approximately symmetrically configured relative to a center line, and so the half below the center line is omitted in FIG. 3.

The automatic transmission 2 is provided with a torque converter 21, a double pinion-type first planetary gear apparatus 22, a single pinion-type second planetary gear apparatus 23, and a single pinion-type third planetary gear apparatus 24. Power output from an output shaft 26 of the automatic transmission 2 is transmitted to drive wheels via a propeller shaft, a differential gear, a drive shaft, and so forth.

A sun gear S1 of the first planetary gear apparatus of the automatic transmission 2 is selectively linked to an input shaft 25 via clutch C3. Also, when the sun gear S1 is selectively linked to a housing via a one-way clutch F2 and a brake B3, rotation in the reverse direction (the opposite direction as rotation of the input shaft 25) is prevented. A carrier CA1 of the first planetary gear apparatus 22 is selectively linked to the housing via a brake B1, and rotation in the reverse direction is always prevented by a one-way clutch F1 provided parallel to the brake B1. A ring gear R1 of the first planetary gear apparatus 22 is linked as a single body to a ring gear R2 of the second planetary gear apparatus 23, and is selectively linked to the housing via a brake B2.

A sun gear S2 of the second planetary gear apparatus 23 is linked as a single body to a sun gear S3 of the third planetary gear apparatus 24, and is selectively linked to the input shaft 25 via a clutch C4. Also, when the sun gear S2 is selectively linked to the input shaft 25 via a one-way clutch F0 and a clutch C1, rotation in the reverse direction relative to the input shaft 25 is prevented.

A carrier CA2 of the second planetary gear apparatus 23 is linked as a single body to a ring gear R3 of the third planetary gear apparatus 24, and is selectively linked to the input shaft 25 via a clutch C2, and is selectively linked to the housing via a brake B4. Rotation of the carrier CA2 in the reverse direction is always prevented by a one-way clutch F3 provided parallel to the brake B4. Also, a carrier CA3 of the third planetary gear apparatus 24 is linked as a single body to the output shaft 26.

The engagement/release state of the clutches C1 to C4, the brakes B1 to B4, and the one-way clutches F0 to F3 of the above automatic transmission 2 are shown in the operation table in FIG. 3. In the operation table in FIG. 4, ‘◯’ indicates engagement and a blank space indicates release. Also, ‘⊚’ indicates engagement during engine braking, and ‘Δ’ indicates engagement unrelated to power transmission.

As shown in FIG. 3, in the automatic transmission 2 in this example, in the first (1S) forward gear (D), the clutch C1 is engaged, and the one-way clutches F0 and F3 operate. In the second forward gear (2nd), the clutch C1 and the third brake B3 are engaged, and the one-way clutches F0, F1, and F2 operate.

In the third forward gear (3rd), the clutches C1 and C3 are engaged, the brake B3 is engaged, and the first one-way clutches F0 and F1 operate. In the fourth forward gear (4th), the clutches C1, C2, and C3 are engaged, the brake B3 is engaged, and the one-way clutch F0 operates.

In the fifth forward gear (5th), the clutches C1, C2, and C3 are engaged, and the brakes B1 and B3 are engaged. In the sixth forward gear (6th), the clutches C1 and C2 are engaged, and the brakes B1, B2, and B3 are engaged.

On the other hand, in the reverse gear (Rev), the clutch C3 is engaged, the brake B4 is engaged, and the one-way clutch F1 operates.

In this way, in the automatic transmission 2 in this example, a gear is set by engaging or releasing the clutches C1 to C4, the brakes B1 to B4, the one-way clutch F0 to F3, and the like, which are frictionally engaging elements, in a predetermined state. Engagement/release of the clutches C1 to C4 and the brakes B1 to B4 is controlled by a hydraulic control circuit 27.

A manual valve 28 that is driven by the range switching apparatus 10, and a linear solenoid valve and an on/off solenoid valve and so forth that are not shown, are provided in the hydraulic control circuit 27. By control of excitement/non-excitement of each solenoid valve, or switching control of the manual valve 28 by the range switching apparatus 10, the hydraulic control circuit 27 is switched, and thus it is possible to control engagement/release of the clutches C1 to C4 and the brakes B1 to B4 of the automatic transmission 2.

Excitement/non-excitement of the linear solenoid valve and the on/off solenoid valve of the hydraulic control circuit 27 is controlled by solenoid control signals (instruction hydraulic signals) from the ECT_ECU 4.

The ECT_ECU 4 outputs solenoid control signals (hydraulic command signals) to the hydraulic control circuit 27 of the automatic transmission 2. The linear solenoid valve, the on/off solenoid valve, and so forth of the hydraulic control circuit 27 are controlled based on these solenoid control signals, so that the clutches C1 to C4, the brakes B1 to B4, the one-way clutches F0 to F3, and so forth are engaged and/or released in a predetermined state so as to constitute a predetermined gear (of the 1st to 6th gears).

Also, when the ECT_ECU 4 has received an appropriate clutch release command from an SBW_ECU 40 described below, the ECT_ECU 4 releases the frictionally engaging elements of the automatic transmission 2 and blocks power transmission from the engine 1 to the drive wheels. Specifically, when the present shift range is ‘drive range D’, the ECT_ECU 4 releases the clutch C1 to put the automatic transmission 2 in a neutral state (a state in which power transmission is blocked). When the present shift range is ‘reverse range R’, the ECT_ECU 4 releases the clutch C3 and the brake B4 to put the automatic transmission 2 in a neutral state (a state in which power transmission is blocked).

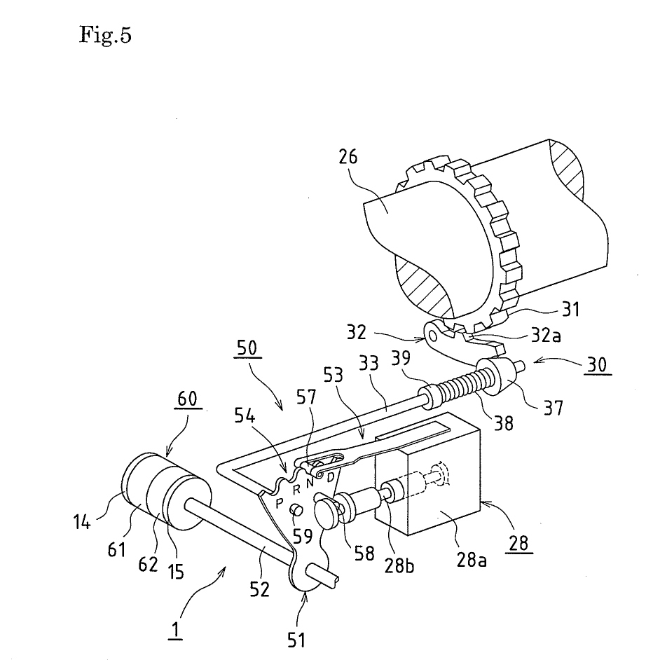

The range switching apparatus 10 will be described with reference to FIG. 5.

The range switching apparatus 10 is a so-called by-wire range switching apparatus, and operates the manual valve 28 for range switching of the automatic transmission, and a parking mechanism 30, in order to establish a shift range (P, R, N, or D) that has been requested by the driver manually operating the parking switch 11, the shift lever 12, or the like. The range switching apparatus 10 mainly includes an SBW_ECU (Shift by Wire Electronic Control Unit) 40, a detent mechanism 50, and an actuator 60.

As described above, the manual valve 28 is one constituent element of the hydraulic control apparatus 27 provided in the automatic transmission 2. When the manual valve 28 has been operated in response to operation of the shift lever 12, the manual valve 28 establishes the range corresponding to that operation by changing of a working oil supply path for the linear solenoid valves. The manual valve 28 is an ordinarily known spool valve type of manual valve, and mainly includes a valve body 28a and a spool 28b.

The valve body 28a is fixed at an appropriate location within the case of the automatic transmission 2 and has an appropriate supply port and discharge port. The spook 28b is housed in the valve body 28a so as to be displaceable in an axial direction.

The parking mechanism 30 switches between a locked state in which the output shaft 26 of the automatic transmission 2 cannot rotate, and an unlocked state in which the output shaft 26 can rotate, and mainly includes a parking gear 31, a parking lock pole 32, and a parking rod 33.

The parking gear 31 is externally fixed to the output shaft 26 of the automatic transmission, such that the parking gear 31 and the output shaft 26 can rotate together as a single body.

The parking lock pole 32 is disposed near the parking gear 31 so as to be capable of tilting with one end as a fulcrum. A catch 32a that can be engaged between teeth of the parking gear 31 or disengaged is provided somewhere in the lengthwise direction of the parking lock pole 32. The parking lock pole 32 is always biased by an unshown spring in the direction that the parking lock pole 32 is pulled away from the parking gear 31.

The parking rod 33 is disposed so as to be displaced to the front end side or the rear end side approximately parallel to the output shaft 26 of the automatic transmission.

As shown in FIGS. 1 and 2, the front end of the parking rod 33 is linked to a detent lever 51 described below, and is pushed/pulled by tilting operation of this detent lever 51.

A tapered cone 37 for tilting the parking lock pole 32 is provided at the rear end of the parking rod 33. The tapered cone 37 is pushed to the parking gear 31 side by a coil spring 38. The coil spring 38 is provided on the outside of the parking rod 33, and one end of the coil spring 38 is retained by a retaining ring 39 that is fastened to the parking rod 33.

The SBW_ECU 40 performs overall control of operation of the range switching apparatus 10, and at least performs processing to switch the shift range between the parking range P and the non-parking range P in response to a signal input from the parking switch 11, and processing to switch to the requested range (R, N, or D) in response to a signal input from the shift sensor 13.

In the SBW_ECU 40, mainly, the parking switch 11, the shift sensor 13, a rotor angle detection means 14, an output angle detection means 15, an oil temperature sensor 16, a brake switch 17, a vehicle speed sensor 18, and so forth are connected via an unshown input interface, and a motor 61 of the actuator 60 and so forth is connected via an unshown output interface. The SBW_ECU 40, at least, executes gearshift processing that switches the automatic transmission 2 to a requested gear by controlling the motor 61 of the actuator 60 as necessary.

In this embodiment, the constituent elements connected to the SBW_ECU 40 are only those related to features of the invention, and elements that are not directly related to features of the invention are not described or noted.

The oil temperature sensor 16 detects the temperature of working oil (ATF) of the automatic transmission 2, the brake switch 17 outputs an off signal in a state in which an unshown foot brake is not being depressed, and outputs an on signal in a state in which the foot brake has been depressed, and the vehicle speed sensor 18 detects running speed of the vehicle.

The rotor angle detection means 14 and the output angle detection means 15 are conventionally known configurations (for example, see PTL2), so these are briefly described, and a detailed drawing or description thereof is omitted. An appropriate configuration other than that described below can also be adopted for the detection means 14 and 17.

The rotor angle detection means 14 detects the rotation angle of a rotor of the motor 61, and is configured using a magnet installed on the outer circumference of the rotor or magnetic poles that have been magnetized with alternately opposite polarities on the outer circumference of the rotor, and a Hall IC for detecting magnetism. The rotor angle detection means 14 is used as a digital encoder or the like that outputs a number of pulses corresponding to the amount of rotation of the rotor.

The output angle detection means 15 detects the rotation angle of the output shaft 63 of the actuator 60, and is configured using a magnet that is installed in the range of a predetermined rotation angle on the outer face side of the output shaft 63 and whose cross-sectional area gradually increases in one circumferential direction, and a linear output Hall IC. The output angle detection means 15 is used as an analog magnetic sensor that detects the magnetic force of the magnet corresponding to the rotation angle of the output shaft 63, and outputs a linear analog signal (voltage) corresponding to that detected magnetic force. For example, a so-called non-contact type neutral switch (NSW) or the like is used as this analog magnetic sensor.

Each of the above ECUs 3, 4, and 40, although not shown in detail, same as an ordinary ECU, are configured including a CPU, a RAM, a ROM, a backup RAM, and so forth, and are connected to each other so as to be capable of bi-directionally sending/receiving necessary information to/from each other. Various control programs, a map or the like referred to when executing those various control programs, and so forth are stored in the ROM. The CPU executes various computational processing based on the various control programs and the map stored in the ROM. The RAM is a memory that temporarily stores the results of computational processing with the CPU, data that has been input from sensors, and so forth. The backup RAM is a nonvolatile memory that stores data or the like to be saved when stopping the engine 1, for example.

In the detent mechanism 50, the spool 28b of the manual valve 28 and the parking rod 33 of the parking mechanism 30 are positioned by being pushed/pulled in steps, and the detent mechanism 50 mainly is configured including the detent plate 51, a support shaft (also referred to as a manual shaft) 52, and a detent spring 53.

The detent plate 51 pushes/pulls the spool 28b of the manual valve 28 and the parking rod 33 of the parking mechanism 30 due to being tilted by the actuator 60.

The detent plate 51 is formed so as to have a fan-like outer shape, and in a region that is the center of tilting of the detent plate 51, in a state in which the support shaft 52, which is a separate body from the detent plate 51, passes through the detent plate 51, the support shaft 52 is fixed so as to be capable of rotating as a single body with the detent plate 51.

Specifically, the detent plate 51 and the support shaft 52 are linked by, for example, providing a cylindrical boss portion (not shown) in a tilting fulcrum portion of the detent plate 51, and fitting the support shaft 52 in an inner hole of the cylindrical boss portion, and for example, hammering in a spring pin or the like (not shown). However, another mode of linkage may also be adopted.

Thus, when the support shaft 52 is rotated, the detent plate 51 rotates (or is inclined) together with the support shaft 52. The detent plate 51 and the support shaft 52 may also be formed as a single body.

One end in the axial direction of the support shaft 52 is linked coaxially and so as to be rotatable as a single body to the output shaft 63 of the actuator 60, and the other end in the axial direction of the support shaft 52, although not shown, is rotatably supported by, for example, an automatic transmission case 3 or the like.

For example, spline fitting is used to link the support shaft 52 of the detent plate 51 and the output shaft 63 of the actuator 60. That is, a male spline (reference omitted) is provided at the outer circumference of one end of the support shaft 52, and a female spline (reference omitted) is provided at the inner circumferential face of a cave portion of the inner diameter side of the output shaft 63 of the actuator 60. Thus, when the support shaft 52 is rotationally driven by a predetermined angle in the forward direction or the reverse direction, the detent plate 51 is tilted.

The front end of the spool 28b of the manual valve 28, and the front end of the parking rod 33 of the parking mechanism 30, are linked to a predetermined position of the detent plate 51. Thus, when the detent plate 51 is tilted, the spool 28b of the manual valve 28 is displaced in the axial direction, and the parking rod 33 is displaced in the axial direction.

As for the manner of linking the spool 28b to the detent plate 51, a pin 58 attached parallel to the support shaft 52 at a predetermined position of the detent plate 51 is provided between two circular plates provided in an outer end portion of the spool 28.

As for the manner of linking the parking rod 33 to the detent plate 51, a bent end portion of the parking rod 33 is inserted into a through hole 59 provided in one end in the lengthwise direction of the detent plate 51, then an unshown snap ring, latching pin, or the like is attached to this bent end portion, or the bent end portion is plastically deformed, thus retaining and fixing the parking rod 33.

The detent plate 51 is tilted in four steps, for example, corresponding to the shift ranges (for example, the parking range P, the reverse range R, the neutral range N, and the drive range D) selected with the shift lever 12, and the spool 28b of the manual valve 28 is displaced in four steps in the axial direction according to the tilting posture of the detent plate 51.

Therefore, a wave-shaped portion 54 is provided on the upper end side of the detent plate 51.

The wave-shaped portion 54 has a number (four) of valleys (reference omitted) corresponding to the four shift range steps (the parking range P, the reverse range R, the neutral range N, and the drive range D) of the shift lever 12. Also, as shown in FIG. 2, marks ‘P’, ‘R’, ‘N’, and ‘D’ are inscribed near the four valleys in the detent plate 51.

The detent spring 53 individually positions and keeps the tilting posture of the four steps of the detent plate 51, is made of a flexible strip-like plate spring, and is configured with a detent roller 57 as an engaging portion rotatably supported by a forked portion at the tip of the detent spring 53.

The detent roller 57, although not shown in detail, has a hollow shape, a support shaft is inserted through the center hole of the detent roller 57, and both ends in the axial direction of that support shaft are fixed to the forked portion of the detent spring 53.

In this embodiment, one end of the detent spring 53 is fixed to the valve body 28a of the manual valve 28, or the like. Also, the detent roller 57 is engaged with any of the valleys in the wave-shaped portion 54 of the detent plate 51, and by installing the detent roller 57 such that in that state, the detent spring 53 itself is slightly elastically deformed so as to have a curved posture, the detent roller 57 is allowed to act so as to push against the bottom of the valley with the elastic restorative force of the detent spring 53, thus strengthening the engaged state.

The actuator 60 drives the detent mechanism 50, and although not shown in detail, includes the electric motor 61, a deceleration mechanism 62, and the output shaft 63.

Although not shown, the actuator 60 is, for example, an externally attached type of actuator that is attached to a case or the like of the automatic transmission 2 with a bolt.

The motor 61, for example, is a brushless SR (Switched Reluctance) motor in which a permanent magnet is not used, and although not shown, is configured with a rotor that is rotatably supported, and a stator that is disposed on the same axis as the rotational center of the rotor.

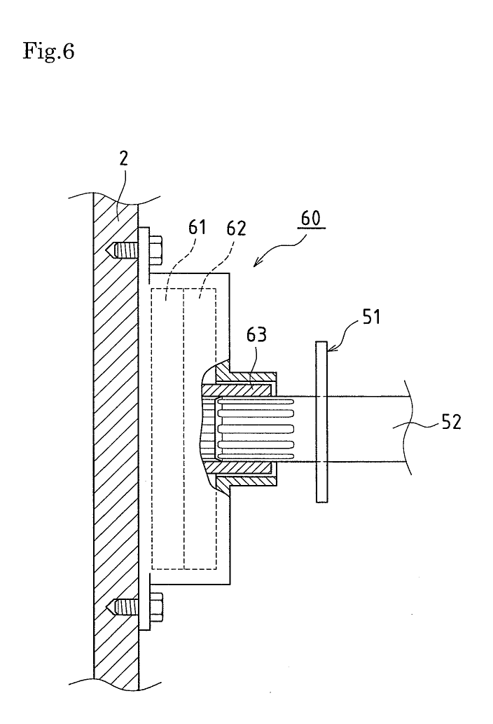

Although not shown in detail, for example, any of a mechanism in which a cycloid gear is used, a gear mechanism in which a plurality of gears are combined, a planetary gear mechanism, or the like is used for the deceleration mechanism 62. An input member (not shown) of the deceleration mechanism 62 is linked to the rotor (not shown) of the motor 61, and the output shaft 63 is provided integrated as a single body with an output shaft (not shown) of the deceleration mechanism 62. As shown in FIG. 6, the support shaft 52 of the detent plate 51 is linked by spline fitting, for example, to the output shaft 63.

Next is a description of basic operation of the range switching apparatus 10 having the above configuration.

When, initially, the driver manually operates the parking switch 11 or the shift lever 12 to select any of the parking range (P), the reverse range (R), the neutral range (N), the drive range (D), and so forth of the automatic transmission 2, the SBW_ECU 40 identifies the range position that has been selected based on the output from the parking switch 11 and the shift sensor 13.

The SBW_ECU 40, according to the results of that identification, drives the output shaft 63 of the actuator 60 so as to rotate in the normal direction or the reverse direction, thus appropriately rotating (tilting) the support shaft 52 and the detent plate 51. Specifically, the SBW_ECU 40 sets a target rotation angle (target pulse count value) that corresponds to the requested range, starts providing electrical power to the motor 61, and performs feedback control of the motor 61 so as to stop the motor 61 at a position where the detected rotation angle (actual pulse count value) of the motor 61 matches the target rotation angle.

Incidentally, with tilting of the detent plate 51, when the mountain of the wave-shaped portion 54 of the detent plate 51 contacts the detent roller 57, the detent spring 53 is temporarily elastically deformed upward, so when the detent roller 57 engages with the valley that is the target of the wave-shaped portion 54, the detent roller 57 is pushed against the valley by the elastic restorative force (biasing force) of the detent spring 53, and so the detent plate 51 is positioned and held motionless.

The spool 28b of the manual valve 28 is slid in the axial direction by this tilting of the detent plate 51, and thus the manual valve 28 is switched to the range position selected among ‘R’, ‘N’, and ‘D’. Thus the hydraulic control apparatus 27 is appropriately driven to establish an appropriate gear in the automatic transmission 2.

The SBW_ECU 40 reads an output signal (voltage value) of the output angle detection means 15, and based on that output signal, identifies the present rotation angle (operation amount of the manual valve 28) of the output shaft 63, i.e., identifies which of the parking range P, the reverse range R, the neutral range N, and the drive range D is the present range (actual range), and by comparing the identified present range (actual range) to the requested range (target range), judges whether or not range switching has been properly performed.

When the parking range P has been selected, the manual valve 28 is switched to the ‘P’ position, and the parking rod 33 of the parking mechanism 30 is slid in the axial direction to engage the catch 32a of the parking lock pole 32 to the parking gear 31. Thus, a locked state in which the output shaft 26 of the automatic transmission 2 cannot rotate is established.

When a range other than the parking range P has been selected from the parking range P position, the SBW_ECU 40 drives the actuator 60 to rotate the support shaft 52 by a predetermined angle in a predetermined direction, so that the detent plate 51 is tilted, thereby sliding the parking rod 33 and the tapered cone 37 in the axial direction in the opposite direction as the direction stated above, so that upward pushing force of the parking lock pole 32 by the tapered cone 37 is released.

Thus, the parking lock pole 32 lowered downward, and the catch 32a thereof is withdrawn from between teeth of the parking gear 31, so that an unlocked state in which the output shaft 26 is rotatable is established. At the same time, the spool 28b of the manual valve 28 is displaced to a target position, forming an appropriate working oil supply path in the hydraulic control apparatus 27.

Next is a detailed description of portions in which features of the invention are applied.

In this embodiment, a configuration is devised such that when a range switching request by operation of the parking switch 11 or the shift lever 12 by the driver has been received, if that range switching request is a specific pattern that reverses the present drive power direction (for example, switching from the reverse range R to the drive range D, or switching from the drive range D to the reverse range R), before starting execution of range switching or immediately after starting execution of range switching, the emitted output of the engine 1 is lowered to a lower limit, e.g., lowered to an idling state.

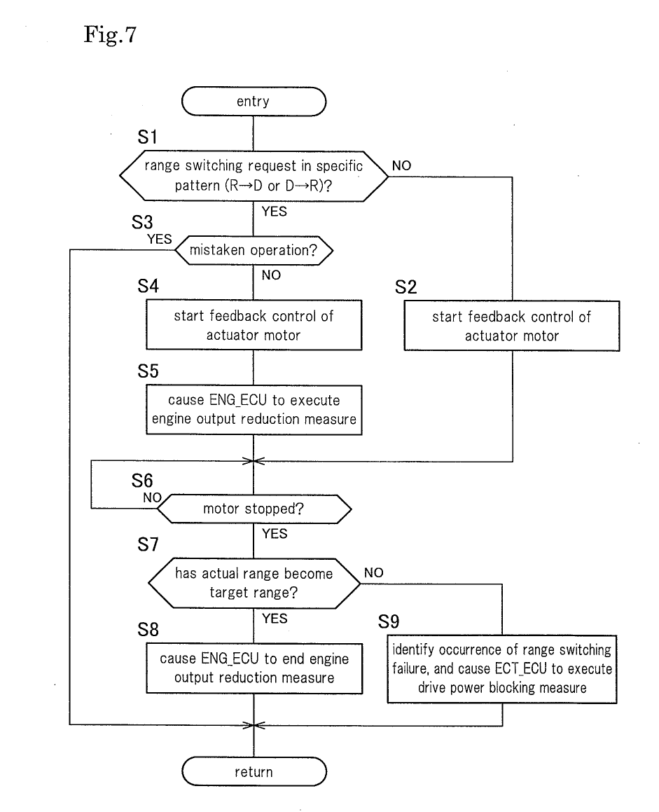

Specifically, range switching control in which features of the invention have been applied will be described with reference to the flowchart shown in FIG. 7. The flowchart in FIG. 7 mainly shows processing by the SBW_ECU 40.

The flowchart shown in FIG. 7 is entered when any of the parking range P, the reverse range R, the neutral range N, the drive range D, and the like have been selected with operation of the parking switch 11 or the shift lever 12 by the driver, and a request for the above range switching has been identified based on a signal output from the parking switch 11 or the shift sensor 13.

First, in Step S1, the actual range (present range) is compared to the target range (requested range), and a judgment is made of whether or not the range switching request is a specific pattern that reverses the drive power direction, e.g., switching from the reverse range R to the drive range D, or switching from the drive range D to the reverse range R. Here, the actual range that is temporarily stored in the internal memory of the control apparatus 40 is read, and compared to the identified target range.

At this time, if the range switching request is a pattern other than the specific pattern (such as P→R, R→P, R→N, N→R, N→D, or D→N), a negative judgment is made in Step 51, and after moving to Step S2, the processing jumps to below Step S6.

In Step S2, a target rotation angle (target count value) of the motor 61 that corresponds to the target range is set, and by starting execution of feedback control of the motor 61, tilting of the detent plate 51 is started. Here, in general, driving of the motor 61 is continued until output (actual pulse count value) from the rotor angle detection means 14 is matched to the target rotation angle (target count value).

Incidentally, if the range switching request is the specific pattern, an affirmative judgment is made in Step S1, and the processing moves to Step S3.

In Step S3, a judgment is made of whether or not the range switching request was received by mistaken operation of the shift lever 12 by the driver.

Ordinarily, a range switching request in the specific pattern is often performed when the vehicle is stopped or at a vehicle speed near to when the vehicle is approximately stopped. Consequently, by investigating whether the vehicle is stopped or at a vehicle speed near to when the vehicle is approximately stopped, or is running at no less than a predetermined vehicle speed, it is possible to identify whether or not mistaken operation has occurred. In order to do so, a judgment is made of whether or not a signal (actual vehicle speed value) input from the vehicle speed sensor 18 is no more than a preset threshold value S0. The threshold value S0 is set to a vehicle speed near to when the vehicle is approximately stopped, for example such as 10 km/h, but can be set as desired.

When the actual vehicle speed value is greater than S0, i.e., when a judgment is made that mistaken operation has occurred, an affirmative judgment is made in Step S3, and this flowchart is exited.

On the other hand, when the actual vehicle speed value is no greater than S0, i.e., when a judgment is made that mistaken operation has not occurred, a negative judgment is made in Step S3, and then processing moves to Step S4.

In Step S4, as in Step S2, a target rotation angle (target count value) of the motor 61 that corresponds to the target range is set, and by starting execution of feedback control of the motor 61, tilting of the detent plate 51 is started.

Next, in Step S5, after outputting a command to execute an engine output reduction measure to the ENG_ECU 3, the processing moves to Step S6. For example, the engine output reduction measure can be processing to put the engine 1 in an idling state. Accordingly, the ENG_ECU 3, when receiving the command to execute the engine output reduction measure, controls the amount of fuel supplied by a fuel supply system (not shown) to the engine 1, so as to put the engine 1 in an idling state.

Next, in Step S6, a judgment is made of whether or not the motor 61 has stopped. The judgment here includes a case in which output (actual rotation angle) from the rotor angle detection means 14 matches the target rotation angle and so the motor 61 properly stopped, and also a case in which defective operation of the motor 61 or the deceleration mechanism 62 occurred so driving to the target rotation angle was not possible and thus the motor 61 stopped due to trouble. Stoppage of the motor 61 can be identified based on output (actual rotation angle) from the rotor angle detection means 14.

Here, when the motor 61 has not stopped, a negative judgment is made in Step S6, and Step S6 is repeated, and when the motor 61 has stopped, an affirmative judgment is made in Step S6 and the processing moves to below Step S7.

In Step S7, the actual range (present range) is compared to the target range (requested range), and a judgment is made of whether or not the actual range has become the target range. Here, an investigation is made of whether or not the output (actual voltage value) from the output angle detection means 15 is in a target voltage range that corresponds to the target range.

When the actual range has become the target range, this means that range switching has properly completed, so an affirmative judgment is made in Step S7 and the processing moves to Step S8. In Step S8, a command for ending the engine output reduction measure is output to the ENG_ECU 3, and then this flowchart is exited.

However, when the actual range has not become the target range, this means that a problem has occurred in the course of range switching, so a negative judgment is made in Step S7, and the processing moves to Step S9.

In Step S9, occurrence of a range switching failure is identified, and a command to execute a drive power blocking measure is output to the ECT_ECU 4. Processing for establishing a neutral state in which drive power is not allowed to be output from the output shaft 26 of the automatic transmission 2, i.e., processing for releasing the clutches and brakes of the automatic transmission 2, can be adopted as the engine output reduction measure.

When the ECT_ECU 4 has received the command to execute a drive power blocking measure from the SBW_ECU 40, the ECT_ECU 4 performs processing that sets an instruction hydraulic pressure of the automatic transmission 2 to a clutch release hydraulic pressure to release the clutches of the automatic transmission 2. For example, when the present range is the reverse range R, the clutch C3 and the brake B4 of the automatic transmission 2 are released, and thus the automatic transmission 2 is put in a neutral state to block drive power output from the output shaft 26. Afterward, this flowchart is exited.

Incidentally, as is clear from the above description of operation, in Steps S5, S8, and S9, the SBW_ECU 40 operates in cooperation with the ENG_ECU 3 and the ECT_ECU 4, so the vehicle control apparatus according to the invention can be said to be configured including the ENG_ECU 3, the ECT_ECU 4, and the SBW_ECU 40.

However, when a single comprehensive control apparatus is adopted rather than adopting a separate ENG_ECU 3, ECT_ECU 4, and SBW_ECU 40, this comprehensive control apparatus corresponds to the vehicle control apparatus according to the invention.

As described above, according to an embodiment in which features of the invention are applied, when the range switching request is a specific pattern so as to reverse the present drive power direction, such as a request to switch from the reverse range R to the drive range D or a request to switch from the drive range D to the reverse range R, output of the engine 1 is put in an idling state at about the same time as execution of range switching is started.

Thus, even if a range switching failure occurs that is an operation malfunction of the switching apparatus 10 in the course of range switching in that specific pattern, and an operating delay occurs that is a concern when executing a failsafe control in which the power transmission path is blocked, during that delay, only creeping force due to the idling state of the engine 1 is transmitted to the drive wheels of the vehicle, so there is little or no vehicle movement. Even if the vehicle moves, that movement becomes as slow and short as possible.

Furthermore, when a range switching request other than in the specific pattern has been received, a measure of putting the engine 1 in an idling state as described above is not performed, so in a case where the range switching has been properly completed, when an acceleration request by the driver was received near the time of that range switching, it is possible to immediately transmit corresponding drive power to the drive wheels. For reference, for example, there may be cases where, after the driver, in the neutral range N, sets the accelerator opening degree to the fully open side to put the engine 1 in an idling state, a switch is made to the drive range D or the reverse range R (so-called D start after N racing), and in such a case, a sudden acceleration start is possible. In this way, response to such an acceleration request when range switching was properly performed is well maintained.

Incidentally, in a case where, for example, there is a request to switch from the neutral range N to the drive range D or the reverse range R, when a range switching failure occurs and so the neutral range N is maintained, it is possible to avoid transmitting drive power to the drive wheels.

The present invention is not limited to only the above embodiment, and all modifications and applications that come within the claims and range of equivalency of the claims are possible. By way of example, other embodiments of the invention are described below.

(1) In the above embodiment, by way of example, the control apparatus according to the invention is applied to an FR (front engine/rear drive)-type vehicle. However, the control apparatus according to the invention is not limited to such an application, and is also applicable to an FF (front engine/front drive)-type vehicle, an MR (mid engine/rear drive)-type vehicle, an RR (rear engine/rear drive)-type vehicle, or a 4WD (four wheel drive)-type vehicle.

(2) The vehicle to which the control apparatus according to the invention is applied is not limited to a vehicle in which only the engine 1 is used as a drive source; the control apparatus according to the invention is also applicable, for example, to a hybrid vehicle in which an engine and an electrical motor such as a motor/generator are both used.

(3) By way of example, above, the vehicle to which the control apparatus according to the invention is applied is equipped with an automatic transmission that sets a gear ratio using a planetary gear mechanism and a plurality of frictionally engaging elements (the clutches C1 to C4 and the brakes B1 to B4). However, the vehicle to which the control apparatus according to the invention is applied is not limited such a vehicle; the control apparatus according to the invention is also applicable to a vehicle equipped with a stepless transmission such as a belt-driven stepless transmission (CVT).

(4) In the above embodiment, by way of example, the rotation angle of the output shaft 63 of the actuator 60 is detected with the output angle detection means 15. However, this is not a limitation of the invention; it is also possible to use a detection means (such as an analog magnetic sensor) that directly detects the tilt angle of the detent plate 51, and it is also possible to use a detection means that detects the operation amount or the like of the spool 28b of the manual valve 28, for example.

(5) In the above embodiment, by way of example, the drive power blocking measure is performed by releasing the frictionally engaging elements (the clutches C1 to C4 and the brakes B1 to B4) provided in the hydraulically driven automatic transmission 2 mounted in the vehicle. However, this is not a limitation of the invention; the drive power blocking measure may be performed by operation of a hydraulic power blocking means (for example, a clutch) provided separate from the automatic transmission 2 in the power transmission path from the crankshaft (output shaft) of the engine 1 to the drive wheels (not shown).

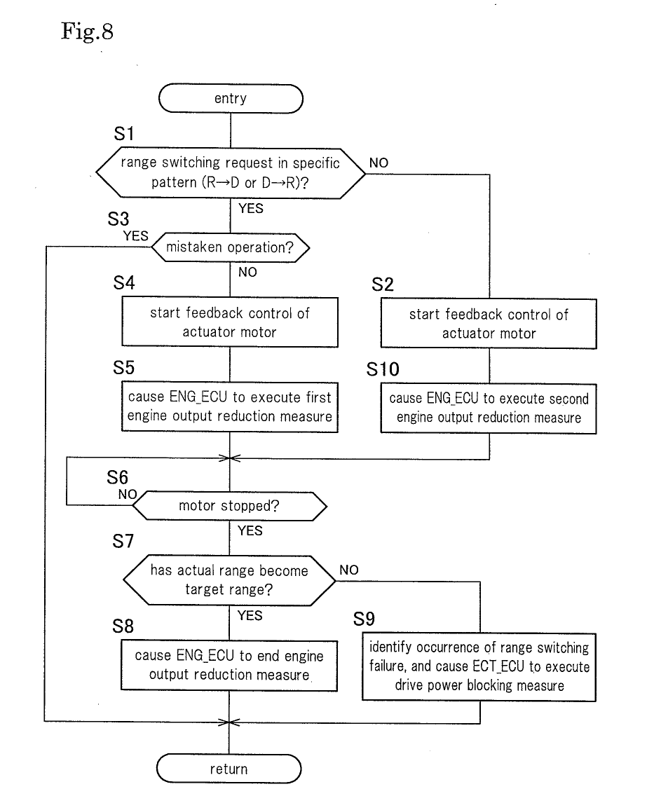

(6) Another embodiment of the invention is shown in FIG. 8. The flowchart in FIG. 8 differs from the flowchart in FIG. 7 in that Step S10 is added after Step S2; thereafter FIG. 8 is basically the same as FIG. 7.

In this embodiment, when the range switching request is a specific pattern so as to reverse the present drive power direction, such as a request to switch from the reverse range R to the drive range D or a request to switch from the drive range D to the reverse range R, at about the same time as execution of range switching is started, a first engine output reduction measure (Step S5 in FIG. 8) that reduces output of the engine 1 is performed, and in addition, when the range switching request was not in the specific pattern, i.e., when a negative judgment was made in Step S1 in FIG. 8, in Step S10 following Step S2 in FIG. 8, at about the same time as execution of range switching is started, a second engine output reduction measure that reduces output of the engine 1 is performed.

The reduction ratio in the first engine output reduction measure is set to a larger ratio than the reduction ratio in the second engine output reduction measure.

(7) In the above embodiments, the engine output reduction measure in Step S5 in FIG. 7, and in Steps S5 and S10 in FIG. 8, can be changed to a drive power restriction measure that adjusts the transmission of drive power from the engine 1 to the drive wheels to a side where that transmission of drive power is reduced.

In this drive power restriction measure, for example, the frictionally engaging elements (such as the clutches C1 to C4 and the brakes B1 to B4) provided in the automatic transmission 2 are used as a hydraulic power transmission adjustment means, and those frictionally engaging elements are compatible with such use by performing control so as to adjust the degree of their engagement and release.

In the case of a drive power restriction measure, the degree of restriction of drive power can be adjusted in consideration of the level of the working oil temperature of the automatic transmission 2.

Specifically, when the ECT_ECU 4 received a command to execute a drive power restriction measure instead of an engine output reduction measure from the SBW_ECU 40 in Step S5 in FIG. 7, or in Steps S5 and S10 in FIG. 8, first, the temperature of the working oil of the automatic transmission 2 is checked based on the output from the oil temperature sensor 16.

Here, based on output (actual working oil temperature) of the oil temperature sensor 16, when judged that the actual working oil temperature (actual oil temperature) is at least a predetermined threshold value THO (actual oil temperature≧THO), the restriction degree in the drive power restriction measure is set to a preset fixed value. On the other hand, when judged that the actual oil temperature is less than the predetermined threshold value THO (actual oil temperature<THO), the restriction degree in the drive power restriction measure is set to a larger value than when the detected oil temperature is at least the predetermined threshold value THO.

Following is a description of reasons for adopting such a configuration.

First, in the operation to switch engagement and release of the frictionally engaging elements (such as the clutches C1 to C4 and the brakes B1 to B4) provided in the automatic transmission 2 as a hydraulic power transmission adjustment means, when the working oil temperature of the automatic transmission 2 is at least the threshold value THO, viscosity of the working oil is high so response is good, but when the working oil temperature of the automatic transmission 2 is less than the threshold value THO, viscosity of the working oil is high so response is poor.

In other words, when the working oil temperature is high, the response of the frictionally engaging elements is good, so even if drive power is restricted after a range switching failure has been detected, an operating delay is unlikely to occur, and therefore the degree of drive power restriction may be small. However, when the working oil temperature is low, response of the power transmission adjustment means is poor, so in consideration of that fact, by setting a larger drive power restriction degree than when the working oil temperature is high, the operating delay (for example, clutch release delay) of drive power restriction is reduced.

The above drive power restriction also encompasses a case where the transmission of drive power from the engine 1 to the drive wheels is set to zero, i.e., a case where the power transmission path from the engine 1 to the drive wheels is blocked.

In this way, only when the range switching request is a specific pattern so as to reverse the present drive power direction, such as a request to switch from the reverse range R to the drive range D or a request to switch from the drive range D to the reverse range R, drive power transmission from the engine 1 to the drive wheels can be restricted at about the same time as execution of range switching is started.

In this case, even if a range switching failure that is an operation malfunction of the switching apparatus 10 occurs in the course of range switching in that specific pattern, it is possible to very quickly respond when executing a failsafe control in which the power transmission path is blocked, so it is possible to eliminate an operating delay of the failsafe control as in the above embodiment. Therefore, even if the driver requests acceleration in a state in which a range switching failure has occurred, drive power is not transmitted to the drive wheels of the vehicle, so there is no vehicle movement at all.

However, when the first engine output reduction measure in Step S5 in FIG. 8, and the second engine output reduction measure in Step S10, are changed to the above drive power restriction measure, the degree of restriction by the first drive power restriction measure in Step S5 in FIG. 8 is set to a greater degree of restriction than the degree of restriction by the second drive power restriction measure in Step S10.

(8) In the drive power restriction measure described in (7) above, it is possible to restrict drive power transmission from the engine to the drive wheels by adjusting braking force using an electronically controlled brake system (ECB) for vehicle wheel braking.

Although not shown, this brake system, in order to realize an ordinarily known braking assist function, anti-lock braking function, and so forth, for example, is provided with a brake hydraulic control circuit in a hydraulic path from a hydraulically controlled master cylinder to a brake caliper, and this brake hydraulic control circuit is appropriately controlled by a control apparatus such as an ECB_ECU.

When the range switching request is identified to be in a specific pattern (such as R→D), or D→R) so as to reverse the present drive power direction, by adjusting the braking force of the vehicle by the brake system, it is possible to set a larger degree of restricting drive power transmission from the engine to the drive wheels than in a case where the range switching request is not in that specific pattern.

The same basic working effects as in the above embodiment can be obtained in this case as well.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

### INDUSTRIAL APPLICABILITY

The present invention is useful for a control apparatus of a vehicle in which a by-wire shift switching apparatus that switches the shift range of an automatic transmission using an actuator has been mounted, and is advantageous in that power transmission can be blocked at an appropriate time when there is a shift switching failure, and moreover, the control apparatus is not particularly influenced by the temperature state of working oil of the power blocking means.

Also, the present invention is useful for a control apparatus of a vehicle in which a by-wire range switching apparatus that performs range switching of an automatic transmission using an actuator has been mounted, and is advantageous in that even if a range switching failure occurs in the course of performing range switching in a specific pattern so as to reverse the present drive power direction, vehicle movement can be suppressed or prevented as much as possible. Furthermore, in addition to being able to suppress or prevent vehicle movement as much as possible, the invention has the advantage that when range switching other than in that specific pattern has been properly completed, response to an acceleration request of the driver is maintained well.

### REFERENCE SIGNS LIST

1 Engine (drive source)
2 automatic transmission
C1 to C4 Clutch (power transmission adjustment means)
B1 to B4 Brake (power transmission adjustment means)
3 ENG_ECU
4 ECT_ECU
10 Range switching apparatus
11 Parking switch
12 Shift lever
13 Shift switch
14 Rotor angle detection means
15 Output angle detection means
16 Brake switch
17 Vehicle speed sensor
27 Hydraulic control circuit
28 Manual valve
28b Spool of manual valve
30 Parking mechanism
33 Parking rod
40 SBW_ECU
50 Detent mechanism
51 Detent plate (detent member)
52 Support shaft of detent plate
53 Detent spring (positioning member)
54 Wave-shaped portion of detent plate
57 Detent roller (engaging portion)
60 Actuator
61 Motor of actuator
62 Deceleration mechanism of actuator
63 Output shaft of actuator

1. A control apparatus of a vehicle in which a by-wire range switching apparatus that performs range switching of an automatic transmission using an actuator is mounted, the control apparatus comprising:
a coping means that, when a range switching request is identified to be in a specific pattern that reverses the present drive power direction, increases the degree of restriction of drive power transmission compared to a case of a range switching request that is not in that specific pattern.

2. A control apparatus of a vehicle in which a by-wire range switching apparatus that performs range switching of an automatic transmission using an actuator is mounted, the control apparatus comprising:
a coping means that, when a range switching request is identified to be in a specific pattern that reverses the present drive power direction, decreases output of a drive source mounted in the vehicle to a lower limit side; and
an execution means that controls the range switching apparatus so as to establish the requested range.

3. A control apparatus of a vehicle in which a by-wire range switching apparatus that performs range switching of an automatic transmission using an actuator is mounted, and also a hydraulic power transmission adjustment means that adjusts drive power transmission from a drive source to drive wheels is mounted, the control apparatus comprising:
a coping means that, when a range switching request is identified to be in a specific pattern that reverses the present drive power direction, decreases output of the drive source to a lower limit side;
an execution means that controls the range switching apparatus so as to establish the requested range;
a confirmation means that checks whether the executed range switching has been properly completed, or a failure has occurred due to an operation malfunction during the range switching; and
a measuring means that, when occurrence of a failure has been detected by the confirmation means, restricts drive power transmission with the power transmission adjustment means.

4. The vehicle control apparatus according to claim 2 or 3,
wherein the drive source is an engine, and an idling state of this engine is the lower limit side of the drive source output.

5. A control apparatus of a vehicle in which a by-wire range switching apparatus that performs range switching of an automatic transmission using an actuator is mounted, and also a hydraulic power transmission adjustment means that adjusts drive power transmission from a drive source to drive wheels is mounted, the control apparatus comprising:
a coping means that, when a range switching request is identified to be in a specific pattern that reverses the present drive power direction, restricts drive power transmission by the power transmission adjustment means; and
an execution means that controls the range switching apparatus so as to establish the requested range.

6. The vehicle control apparatus according to claim 5, further comprising:
a confirmation means that checks whether the executed range switching has been properly completed, or a failure has occurred due to an operation malfunction during the range switching; and
a measuring means that, when occurrence of a failure has been detected by the confirmation means, restricts drive power transmission with the power transmission adjustment means.

7. The vehicle control apparatus according to claim 5,
wherein the coping means, when restricting drive power transmission with the power transmission adjustment means due to receiving a range switching request in the specific pattern, when a low oil temperature is detected based on output of an oil temperature detection means for detecting a working oil temperature of the automatic transmission, increases the degree of restriction compared to when a high oil temperature is detected.

8. The vehicle control apparatus according to claim 3,
wherein the power transmission adjustment means comprises frictionally engaging elements provided in the automatic transmission.

9. A vehicle control apparatus according to claim 1,
wherein the range switching apparatus comprises a detent mechanism for changing the state of a manual valve that is one constituent element of a range switching hydraulic control apparatus provided in the automatic transmission, and an actuator for driving the detent mechanism;
the detent mechanism including a detent member that is displaced by the actuator, and a positioning member that maintains a stopped posture of the detent member;
the detent member having a wave-shaped portion constituted from a plurality of valleys that correspond to each range to which the switching is performed and mountains between the valleys, and the positioning member having an engaging portion that engages with a valley of the wave-shaped portion and generates a biasing force that pushes the engaging portion towards the valley bottom; and
the actuator being controlled to establish a requested range when a range switching request has been received.

10. The vehicle control apparatus according to claim 9,
wherein the actuator tilts the detent member, and comprises an electric motor that generates rotational power, and a deceleration mechanism that decelerates the rotational power generated by this motor and outputs the decelerated rotational power from an output shaft that is linked coaxially and so as to be capable of rotating as a single body with a support shaft of the detent member.

11. The vehicle control apparatus according to claim 10,
comprising a rotor angle detection means that detects the rotation angle of a rotor of the motor, and an output angle detection means that detects the rotation angle of the output shaft of the actuator;
the execution means performing processing that, in response to a range switching request, sets a target rotation angle of the motor that is necessary to engage a valley corresponding to the requested range to the engaging portion, and performs feedback control of driving of the motor until the detected output (actual rotation angle) of the rotor angle detection means reaches the target rotation angle.

12. The vehicle control apparatus according to claim 11,
wherein the confirmation means, when driving of the motor is stopped, determines whether or not a failure has occurred by checking whether or not the valley corresponding to the requested range has been engaged with the engaging portion, based on output of the output angle detection means.
